(19) United States
(12) Patent Application Publication
(10) Pub. No.: US 2025/0094314 A1
(43) Pub. Date: Mar. 20, 2025

(54) SYSTEM, METHOD, PROGRAM, AND INFORMATION PROCESSING DEVICE FOR EFFICIENT CONTROL AND USE OF COMPUTATIONAL RESOURCES

(71) Applicant: CYGAMES, INC., Tokyo (JP)

(72) Inventor: Shuichi Kurabayashi, Tokyo (JP)

(73) Assignee: CYGAMES, INC., Tokyo (JP)

(21) Appl. No.: 18/965,496

(22) Filed: Dec. 2, 2024

Related U.S. Application Data
(63) Continuation of application No. PCT/JP2023/021127, filed on Jun. 7, 2023.

(30) Foreign Application Priority Data
Jun. 17, 2022 (JP) 2022-097815

(51) Int. Cl. G06F 11/3604

(52) U.S. Cl. CPC G06F 11/3604

(57) ABSTRACT

A system is characterized in that: identification information of a computational resource resulting from the execution of processing based on an idempotent and referentially transparent expression (IRTE) is stored in association with identification information of a character string representing the IRTE and a data type of the IRTE; the identification information of the character string representing an IRTE to be executed on the basis of an execution instruction to the system, and the data type, are determined; the stored identification information of computational resources is searched for the identification information of the computational resource associated with the identification information of the character string representing the IRTE to be executed and the data type; and in the case where the identification information is identified, it is determined that the computational resource is used as the result of execution of processing based on the IRTE to be executed.

### TECHNICAL FIELD

The present invention relates to systems, methods, programs, and information processing devices for efficient control and use of computational resources within a system.

### BACKGROUND ART

Recently, systems that run on general-purpose electronic devices, such as smartphones or PCs, and that provide a variety of services, including online games, in which communication is carried out with a server via an open network have become common. In developing such a system, it is necessary to verify the behavior of programs, etc. for causing the system to function. In online games in which a combat-like game based on battles against other users is enjoyed, there is a known format in which a large number of game media such as cards are prepared and battles are performed by using a deck including a plurality of game media selected by a player. Since there is a possibility that problems may arise or the winning rate may be deviated depending on the combination of decks used in the battles, it is necessary to verify the behavior of game programs serving as software and the system while taking the combination of decks into consideration.

However, in the case where the number of the kinds of cards is large, the number of the kinds of decks based on combinations of cards becomes huge. Furthermore, in an online game with which the game service is provided continuously, there are cases where new cards are added in order to maintain fun for users. In such cases, in order to verify factors such as the influence of the addition of new cards on the behavior of the game program and system, it is necessary to conduct testing over a long period by using a huge amount of computational resources.

### CITATION LIST

### Patent Literature

### [PTL 1]

Japanese Unexamined Patent Application, Publication No. 2021-145939

### SUMMARY OF INVENTION

### Technical Problem

Patent Literature 1 discloses a virtualization technology for exhaustively verifying the validity of behavior of a game program (app), based on a large number of deck combinations, on the server side at high speed and in parallel, while putting the game program in a state similar to a real environment. However, with Patent Literature 1, it is necessary to construct a test environment for the game program in the verification system each time a verification test for the behavior of the game program is performed, which results in cases where it cannot be said that computational resources are efficiently controlled and used.

### Solution to Problem

1. The present invention has been made in view of the problem described above and has the following features. Specifically, a system according to an embodiment of the present invention is a system that executes processing based on idempotent and referentially transparent expressions having idempotency and referential transparency, wherein: identification information of a computational resource resulting from the execution of processing based on an idempotent and referentially transparent expression is stored in association with identification information of a character string representing the idempotent and referentially transparent expression as well as a data type of the idempotent and referentially transparent expression; the identification information of the character string representing an idempotent and referentially transparent expression to be executed on the basis of an execution instruction to the system, as well as the data type of the idempotent and referentially transparent expression, are determined; the stored identification information of computational resources is searched for the identification information of the computational resource associated with the identification information of the character string representing the idempotent and referentially transparent expression to be executed as well as the data type of the idempotent and referentially transparent expression; and in the case where the identification information of the computational resource is identified through the search from the stored identification information of computational resources, it is determined that the computational resource identified on the basis of the identified identification information is used as the result of execution of processing based on the idempotent and referentially transparent expression to be executed.
2. In the system in 1, the arrangement may be such that in the case where processing based on a pair of the idempotent and referentially transparent expression to be executed and another idempotent and referentially transparent expression to be executed is to be executed, when the identification information of the computational resource is identified from the stored identification information of computational resources through the search, processing based on the other idempotent and referentially transparent expression is executed by using the computational resource identified on the basis of the identified identification information as the result of execution of the processing based on the idempotent and referentially transparent expression to be executed.

3. In the system in 1 or 2, the arrangement may be such that in the case where the identification information of the computational resource associated with the identification information of the character string representing the idempotent and referentially transparent expression to be executed as well as the data type of the idempotent and referentially transparent expression is not identified from the stored identification information of computational resource, the processing based on the idempotent and referentially transparent expression to be executed is executed, and the identification information of the character string representing the idempotent and referentially transparent expression to be executed and the data type of the idempotent and referentially transparent expression are stored in association with the determined identification information of the computational resource.

4. In a system in any one of 1 to 3, the arrangement may be such that the identification information of the character string representing the idempotent and referentially transparent expression is determined on the basis of a normalized character string of the idempotent and referentially transparent expression.

5. In a system in any one of 1 to 4, the arrangement may be such that the identification information of the character string representing the idempotent and referentially transparent expression is a hash value of the character string.

6. In a system in any one of 1 to 5, the arrangement may be such that the processing based on the idempotent and referentially transparent expression includes at least one of virtual-machine-image creation processing, virtual-machine-instance activation processing, virtual-machine-image modification processing, virtual-machine-image copy processing, container activation processing, and non-destructive data write processing to a storage device by an application.

7. In a system in any one of 1 to 6, the arrangement may be such that the computational resources include at least one of a process running in the system, a processor executing the process, a memory storing information concerning the process, and a memory storing the result of the execution processing.
8. In a system of 7, the arrangement may be such that the process includes at least one of a process of a virtual machine instance and a process for a container.
9. A method according to an embodiment of the present invention is a method for executing processing based on idempotent and referentially transparent expressions by means of a computer, the method including: a step of storing identification information of a computational resource resulting from the execution of processing based on an idempotent and referentially transparent expression in association with identification information of a character string representing the idempotent and referentially transparent expression as well as a data type of the idempotent and referentially transparent expression; a step of determining the identification information of the character string representing an idempotent and referentially transparent expression to be executed on the basis of an execution instruction to the system, as well as the data type of the idempotent and referentially transparent expression; a step of searching the stored identification information of computational resources for the identification information of the computational resource associated with the identification information of the character string representing the idempotent and referentially transparent expression to be executed as well as the data type of the idempotent and referentially transparent expression; and in the case where the identification information of the computational resource is identified through the search from the stored identification information of computational resources, a step of determining that the computational resource identified on the basis of the identified identification information is used as the result of execution of processing based on the idempotent and referentially transparent expression to be executed.
10. A program according to an embodiment of the present invention may cause a computer to execute the method according to 9.
11. An information processing device according to an embodiment of the present invention is an information processing device that executes processing based on idempotent and referentially transparent expressions, wherein: identification information of a computational resource resulting from the execution of processing based on an idempotent and referentially transparent expression is stored in association with identification information of a character string representing the idempotent and referentially transparent expression as well as a data type of the idempotent and referentially transparent expression; the identification information of the character string representing an idempotent and referentially transparent expression to be executed on the basis of an execution instruction to the system, as well as the data type of the idempotent and referentially transparent expression, are determined; the stored identification information of computational resources is searched for the identification information of the computational resource associated with the identification information of the character string representing the idempotent and referentially transparent expression to be executed as well as the data type of the idempotent and referentially transparent expression; and in the case where the identification information of the computational resource is identified through the search from the stored identification information of computational resources, it is determined that the computational resource identified on the basis of the identified identification information is used as the result of execution of processing based on the idempotent and referentially transparent expression to be executed.

### Advantageous Effects of Invention

The present invention makes it possible to efficiently control and utilize computational resources within a system in order to verify programs or a system.

### BRIEF DESCRIPTION OF DRAWINGS

FIG. 1 shows the overall configuration of a system according to an embodiment of the present invention.

FIG. 2 is a hardware configuration diagram of the system according to the embodiment of the present invention.

FIG. 3 is a functional block diagram of the system according to the embodiment of the present invention.

FIG. 4 is a flowchart showing information processing according to the embodiment of the present invention.

FIG. 5 is a schematic illustration showing the operation of the system according to the embodiment of the present invention.

FIG. 6 is a schematic illustration showing reuse of computational resources in a first example of the present invention.

FIG. 7 is a schematic illustration showing reuse of computational resources in a second example of the present invention.

FIG. 8 is a schematic illustration showing reuse of computational resources in a third example of the present invention.

FIG. 9 is a schematic illustration showing reuse of computational resources in a fourth example of the present invention.

### DESCRIPTION OF EMBODIMENTS

The present invention, in one embodiment thereof, employs a system that creates a copy environment of an entire game service including a client app and that performs automated debugging and key performance indicator (KPI) calculation for the app through simulation using the copy environment system. This embodiment is applicable to any system needing verification, without limitation to a game system. In this embodiment, processing for controlling each of cloud machines, containers, the game app, and a distributed cloud storage on a cloud is implemented by using a program written in the form of idempotent and referentially transparent expressions.

An idempotent and referentially transparent expression is an expression having the following two properties: idempotence, with which a certain expression always generates the same result when repeatedly evaluated (executed); and referential transparency, with which, given the same argument, a certain expression always returns the same result. For example, a functional language expression is an example of an idempotent and referentially transparent expression. In this description, the term “functional language expression” is sometimes used in the sense of an idempotent and referentially transparent expression. This embodiment employs programs written in a functional programming language, with which programs are written by using functional language expressions.

An expression is defined as an expression for calling a function, which is the minimum unit representing a function that is executed in a system. Each function has a predefined name. As will be described later, in this embodiment, functions such as a define function, an instantiate function, a launch function, an apply function, a preprocess function, and a post-process function are defined. In the apply function, an exec function for executing a specific play in the game within the function is executed, and the exec function is also handled as a function.

With a functional programming language, it is possible to create a model for an automated verification process including debugging in the form of a repetition of computations having referential transparency and idempotence and to define the behavior of a game system in the form of “a sequence of application of functions”. This makes it possible to temporarily suspend a game environment in entirety or in part when an arbitrary function is applied, saving the status as a snapshot for verification, and to use the snapshot for the purpose of debugging or KPI production.

With an ordinary programming language processing system, since the programming language provides high flexibility, it is necessary to perform data flow analysis in order to discover expressions having equivalence, which results in high costs. Global value numbering, which makes it possible to detect equivalence of expressions at relatively low costs, is widely adopted in compilers; however, it is not possible therewith to detect equivalence of expressions having high granularity, such as expressions for virtual machine generation or cloud resource management. Therefore, with existing technologies, it has generally been the case for programmers to implement original cache mechanisms for cloud resource management instead of depending on data flow analysis in compilers.

In this embodiment, with a programming language in which cloud configuration management is specified on the basis of the paradigm of a functional language, a model for the programming language is defined in the form of a tree stricture including only the definitions and calls of functions, not including any control structures such as conditional branches, recursions, or repetitions. Thus, presupposing that computational resources that have been created are maintained without being modified, global reuse of computational resources on the cloud is realized through 1) assigning the same character string representation to equivalent expressions; 2) providing a function for uniquely associating identification information of a character string representation for an expression in a program for configuring a cloud, the data type of the expression, and an identifier for a resource on the cloud as a triplet; and 3) in the case where a plurality of programs (programs for configuring the cloud) include expressions having the same identification information, on the basis of the principle of “referential transparency”, the value of the expressions is reused when the expressions were evaluated in the past.

This embodiment does not include explicit destructive operations, such as deletion/update operations, for cloud resources that have once been generated, and every resource is created on an ad hoc basis and is deleted upon becoming unnecessary. That is, each computational resource on the cloud is handled as an immutable resource after being created. This makes it possible, in terms of identification information (an ID), to refer to each resource (computational resource) serving as the result of copying, modifying, or activating a virtual machine, deploying a container, executing a client app, or the like on the cloud, without having to consider state changes in cloud resources.

In order to assign the same character string representation to equivalent expressions, it is possible to normalize the program writing order in the tree structure for calling functions in programs. Furthermore, in order to assign the same identification information to equivalent expressions, it is possible to calculate a hash value of a character string representing a program and to use the hash value as identification information.

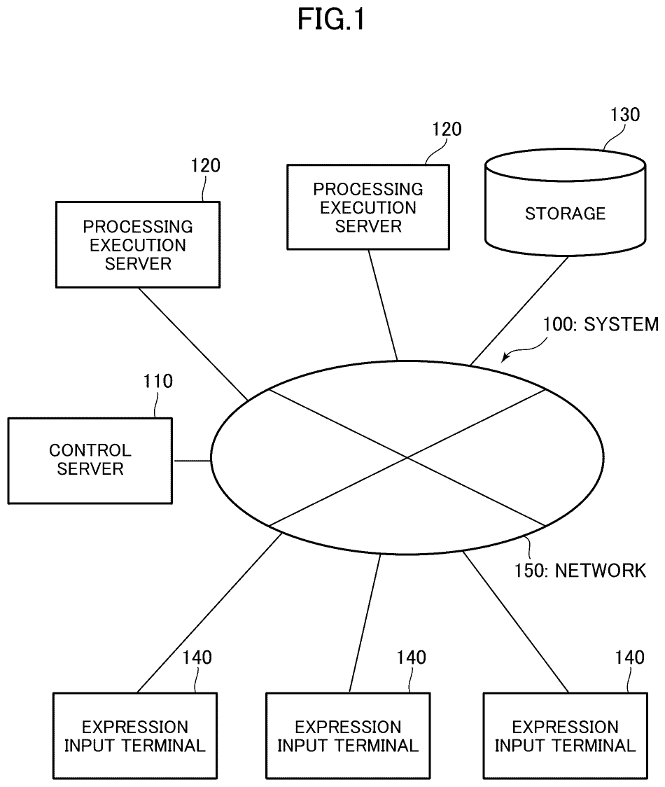

Now, the embodiment will be described with reference to the drawings. As shown in FIG. 1, a system 100 according to this embodiment is realized by a system including a control server 110, one or more processing execution servers 120, one or more storages 130, and one or more expression input terminals 140 connected via a network 150. In this embodiment, the control server 110, the processing execution servers 120, and the storages 130 are accessible as cloud-based servers and distributed storages from the expression input terminals 140 via the network 150, which is the Internet; alternatively, the control server 110, the processing execution servers 120, and the storages 130 may be on-premise servers and storages.

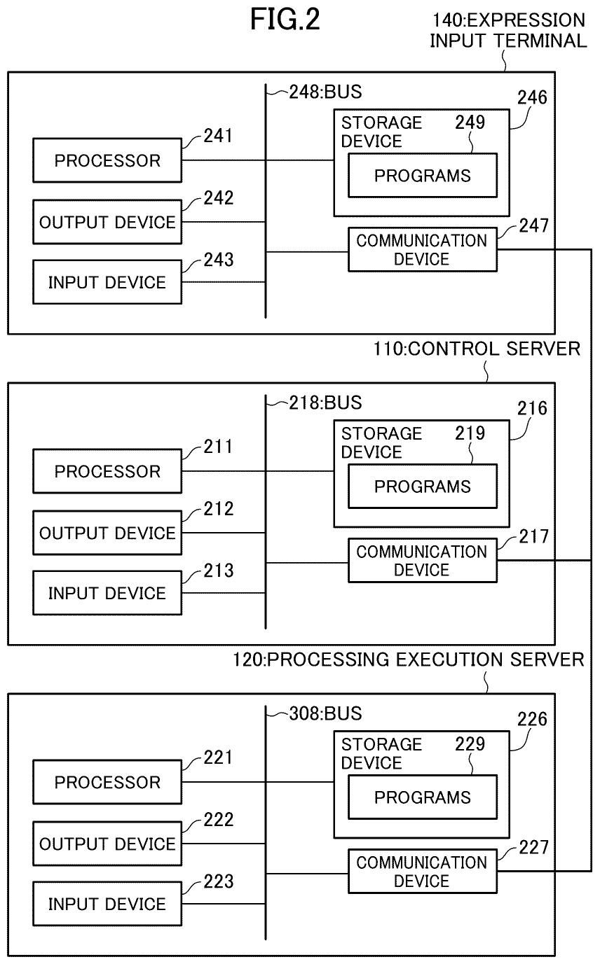

FIG. 2 shows the hardware configuration of the control server 110, the processing execution servers 120, and the expression input terminals 140 in this embodiment. The storages 130 have the hardware configuration of ordinary storages and thus are not shown. The storages 130 may have both a file server function and a database function or may realize one of these functions. The storages 130 may be configured as a part of the control server 110 or the processing execution servers 120 or may be configured as cloud storages that transmit data in response to queries from the control server 110, etc.

The control server 110 is an information processing device that receives an instruction for executing an idempotent and referentially transparent expression from one of the expression input terminals 140 via the network 150, that controls the entire execution processing based on the idempotent and referentially transparent expression while communicating with the processing execution servers 120 and the storages 130, and that generates the result of execution. For example, the control server 110 is an electronic device such as a server. As shown in FIG. 2, the control server 110 may include a processor 211, an output device 212, an input device 213, a storage device 216, a communication device 217, and a bus 218. The storage device 216 stores programs 219, such as a program for controlling the execution of an idempotent and referentially transparent expression.

The processing execution servers 120 are information processing devices that execute various kinds of processing on the basis of programs 229, data input from the input device 223 or data received from the communication device 207, etc. Although only one processing execution server is shown in FIG. 2, a plurality of processing execution servers should preferably be provided as the processing execution servers 120. Furthermore, the processing execution servers 120 may be cloud servers configured to execute processing on the basis of instructions from the control server 110, etc. via the network 150.

The expression input terminals 140 are information processing devices for creating idempotent and referentially transparent expressions and transmitting execution instructions to the control server 110. Although an example of the expression input terminals 140 is computers, the expression input terminals 140 may be other kinds of electronic devices, such as tablets. Each of the expression input terminals 140 may include a processor 241, an output device 242, an input device 243, a storage device 246, a communication device 247, and a bus 248. The storage device 246 stores programs 249, such as a program for creating an idempotent and referentially transparent expression.

The processors 211, 221, and 241 control the overall operations of the control server 110, the processing execution servers 120, and the expression input terminals 140, respectively. For example, the processors 211, 221, and 241 are CPUs. Alternatively, electronic circuits such as MPUs may be used as the processors 211, 221, and 241. The processors 211, 221, and 241 execute various kinds of processing by loading programs and data stored in the storage devices 216, 226, and 246 and executing the programs. In one example, each of the processors 211, 221, and 241 is constituted of a plurality of processors.

The output devices 212, 222, and 242 present application screens, etc. to users of the individual information processing devices under the control of the processors. The output devices 212, 222, and 242 may be liquid crystal displays, organic EL displays, plasma displays or the like. The input devices 213, 223, and 243 are user interfaces that accept inputs to the individual information processing devices from users. For example, the input devices 213, 223, and 243 are keyboards, mouses, touch panels, or touch pads.

The storage devices 216, 226, and 246 are devices that store programs, data, etc. for use in the individual information processing devices. In one example, the storage devices 216, 226, and 246 are storage devices included in ordinary smartphones and computers, including RAMs, which are volatile memories, storage devices using flash memories, such as eMMCs, UFSs, or SSDs, which are non-volatile memories, as well as magnetic storage devices, etc. Furthermore, as storage devices, it is possible to use external memories, file servers, and databases physically separated from the individual information processing devices.

The communication devices 217, 227, and 247 transmit data to and receive data from other devices via the network 150 (not shown in FIG. 2). For example, each of the communication devices connects to the network 150 by carrying out wired communication via an Ethernet (registered trademark) cable or wireless communication such as mobile communication or wireless LAN communication.

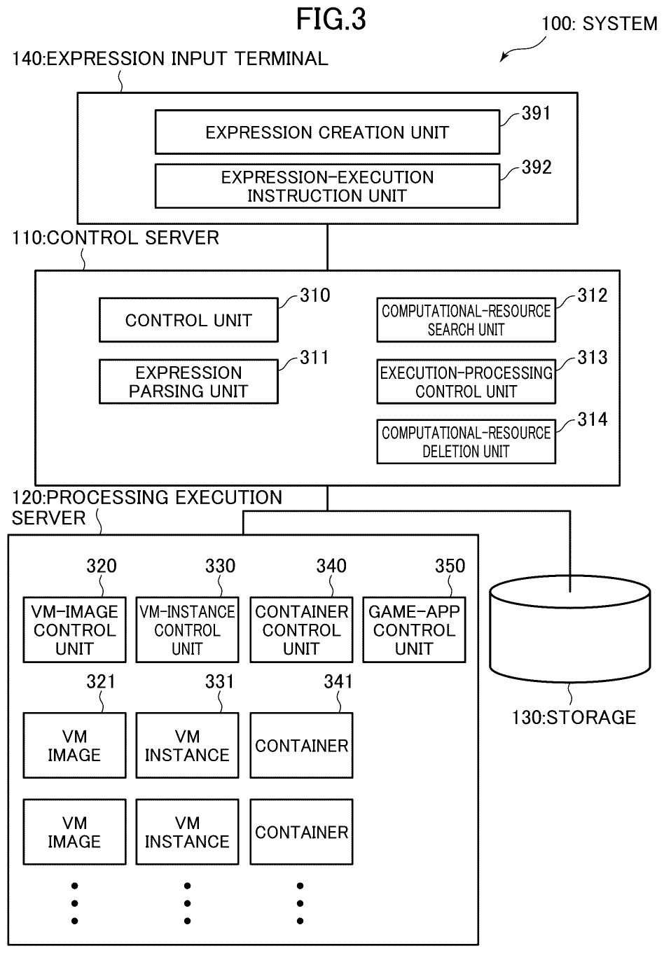

FIG. 3 shows an example functional block diagram of the system 100 according to this invention. The control server 110 includes an expression parser unit 311, a computational-resource search unit 312, an execution-processing control unit 313, and a computational-resource deletion unit 314. The processing execution server 120 each include individual control units 320, 330, 340, and 350, virtual machine (VM) images 321, virtual machine (VM) instances 331, and containers 341. The storage 130 has a function for storing various kinds of data used in this system. The expression input terminals 140 each include an expression creation unit 391 and an expression execution instruction unit 392.

The user of each of the expression input terminals 140 creates an idempotent and referentially transparent expression by using the expression creation unit 391 and transmits an execution instruction including the created idempotent and referentially transparent expression to the control server 110 by using the expression execution instruction unit 392, thereby inputting an idempotent and referentially transparent expression to be executed to the system. Here, it is assumed that the user of each of the expression input terminals 140 is a developer of a game system and that the developer creates a functional language expression serving as an idempotent and referentially transparent expression for verifying the functions of programs for the game system. However, the user may be any person who transmits an execution instruction including an idempotent and referentially transparent expression in order to conduct system verification, and the system need not be a game system.

In the control server 110, on the basis of an execution instruction received from any one of the expression input terminals 140, the control unit 310 causes the expression parsing unit 311 to determine identification information of the character string representing the idempotent and referentially transparent expression included in the execution instruction, as well as the data type of the idempotent and referentially transparent expression. The identification information of the character string representing the idempotent and referentially transparent expression may be determined on the basis of a normalized character string of the idempotent and referentially transparent expression. This makes it possible to ensure uniqueness of identification information of the character string representing the idempotent and referentially transparent expression. Furthermore, an example of the identification information of the character string representing the idempotent and referentially transparent expression is a hash value of the character string.

In the case where the idempotent and referentially transparent expression included in the execution instruction from the expression input terminal 140 is constituted of a set of a plurality of idempotent and referentially transparent expressions, the set is divided into individual idempotent and referentially transparent expressions, and computational resource searching or execution processing is executed for each of the idempotent and referentially transparent expressions resulting from the division. It is possible to perform computational resource searching or execution processing for other expressions by using the result of execution of each expression.

For example, in the case of executing computational resource searching or execution processing with one expression, when identification information of a computational resource is identified from stored identification information of a computational resource through searching, in processing for another expression referring to the abovementioned expression, it is possible to execute processing using the computational resource while substituting the computational resource identification information for the result of the expression referred to.

The expression parsing unit 311 decomposes the idempotent and referentially transparent expression received by the control unit 310 into subexpressions. For the purpose of decomposition into subexpressions, it is possible to select, as appropriate, a decomposition method suitable for realizing efficient control and operation of computational resources. For example, decomposition may be performed into subexpressions corresponding to individual functions of functional language expressions included in a script, or decomposition may be performed into subexpressions corresponding to portions corresponding to computational resources to be managed. In the case where the define function for defining virtual machine images includes an array and each element of the array defines a virtual machine image, decomposition may be performed while considering the individual elements of the array as subexpressions. In this description, there are cases where the term “idempotent and referentially transparent expressions” refer to subexpressions resulting from division.

The computational-resource search unit 312 searches for a computational resource associated with the identification information of the character string representing the idempotent and referentially transparent expression to be executed, determined by the expression parsing unit 311, as well as the data type of the idempotent and referentially transparent expression. Here, it is assumed that the search is executed as a result of transmitting a search instruction to any one of the processing execution servers 120 and the storages 130. Alternatively, the arrangement may be such that the computational-resource search unit 312 stores the identification information of available computational resources such that the hash values and data types of idempotent and referentially transparent expressions are associated with the identifiers of the computational resources and executes a search for a computational resource with reference to the association table. Instead of using the type, a search may be performed on the basis of an association table of the hash values and the identification information of computational resources alone.

Then, when identification information of a computational resource has been identified through a search, it is determined that the computational resource identified on the basis of the identified identification information is to be used as the result of execution of processing based on the idempotent and referentially transparent expression to be executed, and the result is transmitted to the control unit 310.

In the case where no computational resource is identified by the computational-resource search unit 312, the execution-processing control unit 313 executes processing based on the idempotent and referentially transparent expression to be executed, and stores the identification information of the newly generated computational resource in association with the identification information of the character string representing the idempotent and referentially transparent expression to be executed and the data type of the idempotent and referentially transparent expression. Although it is assumed here that the execution-processing control unit 313 transmits a processing execution instruction for executing processing based on the idempotent and referentially transparent expression to be executed to one of the processing execution servers 120, thereby causing the processing execution server to execute processing, the processing may be executed within the control server 110.

In storing the identification information of the determined computational resource in association with the identification information of the character string representing the idempotent and referentially transparent expression to be executed and the data type of the idempotent and referentially transparent expression, it suffices to associate these three items of information in a table in some ways, without limitation to storing the three items of information in mutual association. For example, also in the case where the hash value of an expression and the identification information of a computational resource resulting from the execution of the expression are stored in association in a control unit associated with the data type of the expression, as in this embodiment, it is considered that the identification information of the determined computational resource is stored in association with the identification information of the character string representing the idempotent and referentially transparent expression and the data type of the idempotent and referentially transparent expression.

The computational-resource deletion unit 314 functions as a garbage collector for deleting computational resources. For example, it is possible to delete computational resources that have become unnecessary by using a reference count or the function of an expiration timer on the cloud. In the present invention, since reference relationships among computational resources are defined as reference relationships (passed as arguments or not) among functions of idempotent and referentially transparent expressions, it is possible to readily generate a reference graph. Furthermore, unlike ordinary programming languages, since it is not possible to define a reference in which the result of a computation refers to the result of another computation, it is not necessary to take circular references into consideration. Thus, it is possible to realize the garbage collector in this embodiment extremely simply, and it is possible to implement a sufficiently efficient garbage collector by using the function of an expiration timer on the cloud as-is.

It is assumed here that the individual control units of each of the processing execution servers 120 are a VM-image control unit 320, a VM-instance control unit 330, a container control unit 340, and a game-app control unit 350. It is assumed that the individual control units are realized by executing subprograms corresponding to the individual control units, which are executed at the processing execution server 120. In this embodiment, it is assumed that one control unit is provided in association with each single data type of idempotent and referentially transparent expression. Alternatively, one control unit may be provided for a plurality of data types.

Search instructions from the computational-resource search unit 312 and processing execution instructions from the execution-processing control unit 313 of the control server 110 activate application programming interfaces (API) corresponding to the types of expressions at the control server 110 and are executed on the individual corresponding control units 320, 330, 340, and 350 via the APIs.

For example, the function that is called by an expression is the define function, the data type of the expression is the type “VMImage”. Thus, an image API is activated at the control server 110 as the API corresponding to the type and transmits an instruction, and the VM-image control unit 320 executes the instruction. In the case where the function is launch (activation of an instance or activation of a container), the data type is “VMInstance” or “ContainerInstance”. Thus, a VM instance API or a container API corresponding to these functions is activated, and the VM-instance control unit 330 or the container control unit 340 executes an instruction. In the case where the expression is the exec function, the data type is the type “PlayResult”. Thus, a game app API is activated, and the game-app control unit 350 executes an instruction.

In this embodiment, with a search instruction, the search instruction is received by one of the processing execution servers 120, which determines whether or not a VM image already created has been saved on the basis of the identification information of the expression to be executed, given as an argument. For example, an association table of hash values serving as identification information vs VM-image identification information is stored in the VM-image control unit 320, which makes it possible to determine whether or not a VM image corresponding to the hash value given as an argument in the search instruction is stored on the basis of the association table. In the case of the launch (activation of an instance or activation of a container), the data type is “VMInstance” or “ContainerInstance”. Thus, a VM instance API or a container API corresponding to these data types is activated, which makes it possible to determine whether or not a VM instance or a container resulting from the execution of the expression to be executed is already available on the basis of the hash value.

Each of the control units 320, 330, 340, and 350 executes processing based on the idempotent and referentially transparent expression on the basis of a processing execution instruction from the execution-processing control unit of the control server 110. Upon the completion of the processing for executing the idempotent and referentially transparent expression, each of the control units maintains the generated computational resource in an available state and transmits information for identifying the computational resource to the control server 110.

Processing for executing an idempotent and referentially transparent expression includes virtual-machine-image creation processing, virtual-machine-instance activation processing, virtual-machine-image modification processing, virtual-machine image copy processing, container activation processing, and non-destructive data write processing from an application to a storage device. Virtual-machine-instance activation processing is referred to as virtual-machine-instance generation processing in some cases. Non-destructive data write processing refers to not subjecting already stored data to destructive processing, such as overwriting or updating of existing data. An example of non-destructive data write processing is processing for writing an application execution log to a storage device.

A virtual machine image is data for activating a virtual machine, in which all the content in the memory and hard disk of the virtual machine is saved. A virtual machine image is created in order to activate a virtual machine, and it is possible to modify or copy the virtual machine image for the purpose of subsequent reuse, etc.

In this description, a virtual machine that acts as an entity, which is generated when a virtual machine image is loaded into the virtual machine, will be referred to as a virtual machine (VM) instance. It is possible to activate a virtualized machine, i.e., to generate an instance for a virtual machine, by executing virtual-machine-instance activation processing on the basis of a created virtual machine image. For example, it is possible to activate a virtual server by inputting an image file for a server to a virtual machine.

Furthermore, it is possible to activate a container in a machine and to execute an app virtualized by way of container-based virtualization. Container-based virtualization is a virtualization method that enables virtualization on a per-process basis. For example, it is possible to use container-based virtualization when virtualizing an app itself that is executed on smartphones. In the present invention, what are virtualized with virtual machine instances may be servers or user terminals, and container-based virtualization makes it possible to virtually execute apps that run on these devices.

In the case where the processing for executing an idempotent and referentially transparent expression is virtual-machine-image creation processing, the VM-image control unit 320 generates a VM image 321 and saves the VM image in association with identification information that enables identification within the processing execution server 120. For example, computational-resource identification information (ID) is assigned to the created VM image and is saved, and a table associating the identification information with the identification information of the idempotent and referentially transparent expression is stored in the VM-image control unit 320. Then, the computational-resource identification information of the generated VM image is transmitted to the control server 110 as the result of execution of the virtual-machine-image creation processing. The computational-resource identification information is information that makes it possible to uniquely identify a VM image in the system 100.

If the processing for executing an idempotent and referentially transparent expression is virtual-machine-instance activation processing, virtual-machine-image modification processing, or virtual-machine-image copy processing for a virtual machine, the VM-instance control unit 330 executes the processing and transmits computational-resource identification information identifying the VM instance generated as a result of execution to the control server 110. If the processing for executing an idempotent and referentially transparent expression is generating a container for further activating a prescribed application on the VM instance, identification information identifying the container is the computational-resource identification information. In the case where the processing for executing an idempotent and referentially transparent expression is container activation processing or the like that is executed on the VM instance, the container control unit 340 executes similar processing.

In the case where the processing for executing an idempotent and referentially transparent expression is processing with which a prescribed parameter is input to an application and a result of calculation is output, the game-app control unit 350 executes the processing, causes the storage 130 to store the output calculation result, and transmits identification information identifying the calculation result to the control server 110 as computational-resource identification information. Alternatively, the arrangement may be such that the calculation result itself as well as identification information are transmitted to the control server 110.

In this embodiment, computational resources are the VM images 321, the VM instances 331, the containers 341, data serving as the results of execution, etc. However, computational resources may include all kinds of computational resources on the system. For example, computational resources include processes that are being executed, such as a process of a virtual machine instance, which is a process in which a virtual instance is executed, an application process, in which an application is executed, and a process of an activated container. Furthermore, computational resources also include processing devices that execute processes, and storage devices that store information necessary for the execution of the processes and data serving as the results of execution, storage areas of storage devices.

As a response to the processing execution instruction, the execution-processing control unit 313 of the control server 110 transmits the computational-resource identification information received from the processing execution server 120 or the result of calculation to the control unit 310 as the result of execution. On the basis of the result of execution received from the computational-resource search unit 312 or the execution-processing control unit 313, the control unit 310 transmits a response to the execution instruction from the expression input terminal 140. The response may include the result of execution and other information relating to the execution, such as log information.

In this embodiment, the individual functional units are realized through cooperative operation of the individual hardware devices including the output device, the input device, the storage device, and the communication device as well as software by executing the programs included in the hardware configuration shown in FIG. 2 by the processing device. Alternatively, the individual functional units may be realized by providing electronic circuits or the like corresponding to the individual functions.

In this embodiment, with a programming language in which configuration management for a system including a large number of computational resources, preferably a cloud system, is specified according to a paradigm of idempotent and referentially transparent expressions in a functional language or the like, a model for the programming language is defined in the form of a tree structure including only the definitions and calls of functions, not including any control structures such as conditional branches, recursions, or repetitions. It becomes possible to realize efficient control and use of computational resources through 1) assigning the same character string representation to equivalent expressions by normalizing the program writing order on the tree structure for calling functions in programs; 2) providing a function for uniquely associating identification information (hash value) of a character string representation for an expression in a program for configuring a cloud, the data type of the expression, and an identifier for a resource on the cloud as a triplet; and 3) in the case where a plurality of programs (programs for configuring the cloud) include expressions having the same identification information (hash value), on the basis of the principle of “referential transparency”, the value of the expressions is reused when the expressions were evaluated in the past.

Math 1 shows an example script written by using functional language expressions serving as idempotent and referentially transparent expressions used in this embodiment. This example is used for game app verification that is executed by using cloud infrastructure. The script can be implemented as a language processing system that gives cloud configuration information and that parses information concerning auto-execution of a game and that executes the game.

[Math 1]

```
{
  ″header″:{
    ″type″: ″GameA,
    ″version″] ″1. 0.0″
  },
    ″define″:[
    {
        ″reference_id″: ″$api-server″,
        ″method″: ″create″,
        ″region″: ″ap-northreast″,
        ″maxwait″: 1200000,
        ″ImageId″: ″ami-0123456789abcd″,
        ″InstanceType″: ″c5.24xlarge″,
        ″EbsOptimized″: true,
        ″BlockDeviceMappings″:
        ″IamInstanceProfile″:
        ″NetworkInterfaces″:
        ″TagSpecifications″:
      },
  ],
    ″instantiate″: {
      ″aws_settings″:
      ″addhost_fqdn″: ″dev.testcase.jp″,
      ″polling_settings″:
    },
  ″launch″: [
    {
      ″num″: 10,
      ″options″: [ ]
      ″additionalOptions″: { }
      }
  ],
″apply″: {
    ″app_version″: ″3. 3.0″,
    ″resource_version″: ″2311test11″,
    ″s3bucket″: ″test_example″,
    ″s3prefix″: ″replaylog/example″,
    ″server_log_prefix″: ″server/log″,
    ″region″: ″ap-northeast″,
    ″repeat_count″: 1,
    ″sequential_threashold″: 0.9,
    ...
    } ,
  ″preprocess″: { }
  ″postprocess″
}
```

A script such as the one shown in Math 1 is defined in the form of a set of expressions given in JSON. define is a functional expression for defining a virtual machine image. The definition can include a plurality of definitions in the form of an array. instantiate is a functional expression for defining a method for activating a virtual machine instance, and launch specifies activation of a virtual machine instance and activation of a container. apply defines a method for an auto-play of the game system to be developed. It is possible to specify parameters for an auto-play and a storage location for the result of the auto-play. As described above, it is possible to define control for computational resources on the cloud in the form of a sequence of definitions of functions and applications of functions.

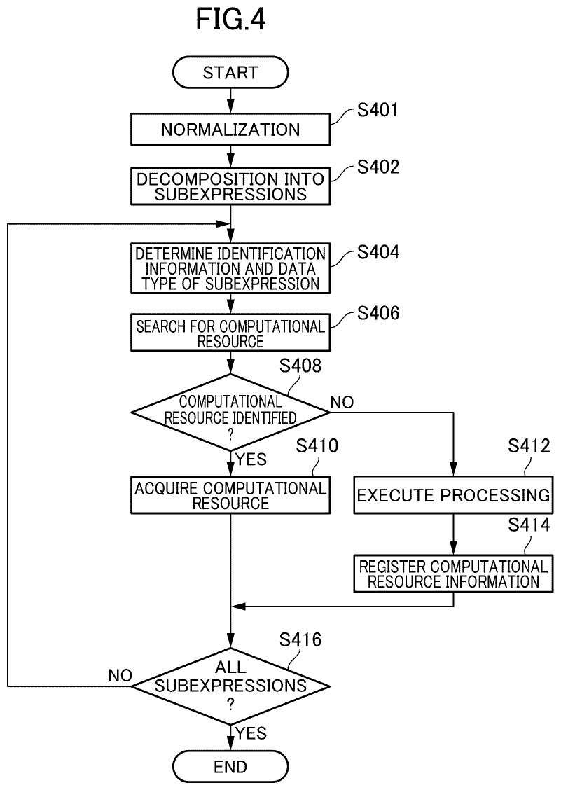

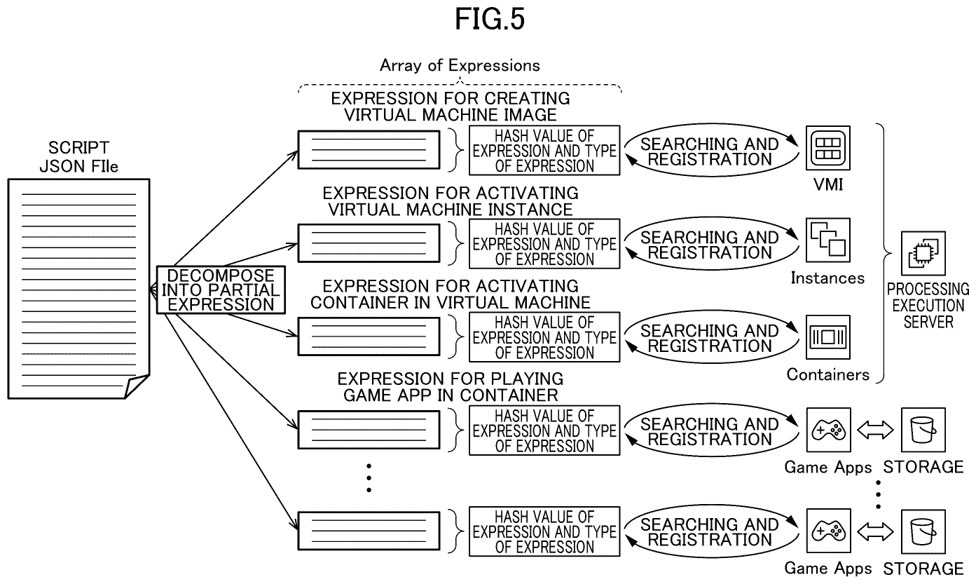

Next, a process that is executed at the system 100 in this embodiment will be described on the basis of a flowchart shown in FIG. 4. As an example, the description will be given in the context of the case where a JSON file, which is a script file in which a method for constructing cloud infrastructure, the content of a play to be executed in a game app, and parameters for calculating a KPI are declaratively defined, is input to the system. FIG. 5 shows a schematic illustration of the operation of the system in the case where this example is used.

First, by using one of the expression input terminals 140, the user of the expression input terminal 140, who is a developer of a game system, creates a JSON file in which character strings representing a plurality of functional language expressions are written as a script for verifying a game app, and transmits the JSON file to the control server 110 together with an instruction for executing idempotent and referentially transparent expressions.

When the instruction is received by the control server 110, the expression parsing unit 311 normalizes the character strings in the script in the JSON file (S401). In this embodiment, the attribute names are sorted according to the dictionary names of the attribute names (e.g., the order of occurrence in the code point tables of Unicode) as a criterion in all layers of the received JSON file, thereby normalizing the script. This method is called deterministic JSONization, and it would be clearly understood by a person skilled in the art that it is possible to realize the method by using json-stable-stringify, fast-json-stable-stringify, or the like. By normalizing the order of occurrence of the attribute names in all layers of JSON, as described above, it is possible to assign the same character string representation to script files for executing the same function.

Furthermore, in the case where the normalized script includes a plurality of subexpressions, the script is decomposed into the subexpressions (S402). Here, as shown in FIG. 5, the script is decomposed into an expression for creating a virtual machine image, an expression for activating a virtual machine instance, an expression for activating a container in a virtual machine, an expression for playing a game app in a container, etc.

The system executes processing from S404 to S416 on each of the subexpressions resulting from the decomposition. The expression parsing unit 311 determines identification information and data type of the subexpression (S404). The identification information of the subexpression may be calculated by using any method as long as the identification information enables unique identification of the character string. In this embodiment, a hash function (SHA256) is used. As an example, with the exec function for activating a single game play, the character string obtained by normalizing parameters for a single play, “1030410201040210301042130101052410101060240101060410101082410 20108241030110241010111041010111041020112011020112032010112211 02011224103011501301011523101011702301011703101011721101011822 40101210210101210230101210310101210340101210410101210440101212 11010121211020121211030121214010121221010121221020121224010121 231010121234010121241010121241020800234030900041150”, is converted into “e841bd5de2c588aa8330ade0cb42c65cbce49979ef3e8c926f433f4f8b70b 8ab” according to SHA256, and this value is used as a hash value serving as the identification information of the exec function.

The data type can be identified on the basis of the function of each subexpression. For example, the data type can be identified on a rule basis per function of each subexpression. For example, the data type can be identified such that the data type is “VMImage” in the case of the define function, the data type is “VMInstance” or “ContainerInstance” in the case of the launch function, and the data type is “PlayResult” in the case of the exec function.

The computational-resource search unit 312 searches for a computational resource corresponding to the hash value serving as the calculated identification information of the subexpression, as well as the data type thereof (S406), and determines whether or not the subexpression has been executed and is available as an available resource (S408). In the case where it is determined that the computational resource is available, the identified (discovered) available computational resource is acquired (S410).

Acquiring a computational resource refers to putting the computational resource in an available state. For example, in the case where the function of the subexpression is launch for activating a virtual machine instance, the VM instance activated with the subexpression is made available. In the case of the exec function, data of the result of the game executed with the parameters of the subexpression is acquired.

The computational resource may be a process running in the system or a processor executing the process. In this case, putting the computational resource in an available state may be, for example, assigning information identifying the running process or the processor executing the process or assigning a privilege for accessing the process or the processor. Furthermore, the computational resource may be a storage device or a storage area. In this case, putting the computational resource in an available state may be assigning information identifying the storage device or storage area in which data serving as the result of execution is stored or assigning a privilege for accessing the storage device or storage area.

In this embodiment, since it is possible to refer to another expression by the name from within an expression, the parsing unit 311 can substitute the result of the expression referred to as the identifier of the computational resource via the computational-resource search unit 312 and can execute processing for the subsequent subexpressions. Also in the case where an expression is newly executed by the processing execution server 120, it is possible to substitute newly generated computer resource information for the expression.

In this embodiment, a search for a computational resource is realized by activating an API corresponding to the data type and executing a search instruction by using the activated API while using the hash value as a parameter. The control unit of the processing execution server 120, corresponding to a computational resource corresponding to each API, searches for the computational resource on the basis of the search instruction. In the case where the result of execution for a subexpression is identified, as the result of execution of the subexpression, the control server 110 acquires at least one of the identification information of the computational resource and the execution result data itself serving as the computational resource.

For example, in the case of the define function, the data type is “VMImage”, the image application programming interface (API) is activated as the API corresponding to the type, and a search instruction is executed while using the hash value of the define function to be executed as an argument. In this embodiment, the VM-image control unit 320 of the processing execution server 120 receives the search instruction and determines whether or not a VM image already created has been saved on the basis of the hash value given as an argument. Here, it is possible to determine whether or not a VM image corresponding to the hash value is stored on the basis of the association table of hash value vs VM-image identification information, stored in the VM-image control unit 320.

In the case of the launch function (activation of a virtual machine instance or activation of a container), the data type is “VMInstance” or “ContainerInstance”, respectively, the VM instance API or the container API corresponding to these data types is activated, which makes it possible to perform a search as to whether or not the result of execution of the subexpression to be executed is already available on the basis of the hash value. In this case, the result of execution is the VM instance 331 or the container 341 activated in the processing execution server 120. Whether the type is “VMInstance” or “ContainerInstance” can be identified, for example, on the basis of a parameter of the launch function.

In the case where a VM instance 331 or a container 341 corresponding to the hash value of the expression is found as a result of the search, the VM instance 331 or the container 341 is put into an available state in the script that is being executed. Here, a privilege for using the VM instance 331 is granted to the process executing the script so that the VM instance 331 can be used in other subexpressions. For example, it is possible to grant a privilege for accessing the VM instance 331 and to give the identification information of the VM instance 331 to the control server 110, which makes it possible for other subexpressions in the script to activate containers in the VM instance 331 on the basis of the received VM-instance identification information.

In the case of the exec function, the data type is “PlayResult”. In this case, the game app API for accessing the storage 130 in which the result of execution is stored is activated, which performs a search as to whether or not the execution result data is stored in the storage 130. The storage 130 stores an association table of hash values and execution result data, and it is determined whether or not a calculation result corresponding to the hash value is stored on the basis of a search instruction via the game app API. In the case where a calculation result already stored is identified, the calculation result itself may be returned to the control server 110 as the result of execution of the subexpression, or identification information for identifying the address of the storage area in which the calculation result is stored may be returned in order to acquire the calculation result.

In the case where an available computational resource could not be identified, processing based on the subexpression to be executed is executed (S412), and the identification information of the computational resource serving as the result of execution is newly registered in association with the identification information of the subexpression (S414).

In this embodiment, the API corresponding to the type of the subexpression to be executed is activated, which transmits the execution instruction to one of the control units of the processing execution server 120, and the control unit that has received the execution instruction executes processing based on the subexpression. For example, in the case where the subexpression is the define function for defining a virtual machine image, the image API is activated, and a VM-image generation instruction including the parameter of the define function as an argument is transmitted. Upon receiving the VM-image generation instruction, the control unit 320 of the processing execution server 120 generates a VM image, stores the identification information of the created VM image in association with the hash value of the subexpression, puts the created VM image into an available state, and transmits the identification information to the control server 110.

In the case where the expression to be executed is an expression for activating a virtual machine, a VM-instance activation instruction is transmitted by using the VM instance API. Then, the VM-instance control unit 330 that has received the activation instruction activates a VM instance, stores the instance in association with the hash value of the expression, and transmits information identifying the activated VM instance to the control server 110. For example, by giving the identification information of a VM image for activating a VM instance as an argument of an instance activation instruction, it is possible to activate a VM instance by using a VM image already stored in the processing execution server 120. The APIs for executing functions may be different from the APIs for searching for computational resources.

In the case where the expression to be executed is the exec function and is an expression for calculating a play result of a game app, the game app API is activated, and an execution instruction including a game play parameter as an argument is transmitted. Then, the game-app control unit 350 of the processing execution server 120 receives the execution instruction, executes a game play, stores the result of execution in the storage 130 in association with the hash value of the subexpression, and transmits the game play result to the control server 110.

When the processing on the subexpression is finished, it is determined whether there is any remaining subexpression in the script (S416). In the case where there is any remaining subexpression, S404 to S416 are executed repeatedly until no subexpression remains. When no subexpression remains, the processing for executing the script comes to an end.

In the case of the example shown in FIG. 5, the script JSON file is decomposed into an expression for creating a virtual machine image, an expression for activating a virtual machine instance, an expression for activating a container in a virtual machine, an expression for playing a game app in a container, etc. Furthermore, the hash value of each subexpression is calculated, and the expression type thereof is determined. For each subexpression, processing for searching for or registering a computational resource based on the subexpression is executed on the basis of the determined hash value and type.

In the search and registration processing, the search destination and the registration destination are determined on the basis of the data type of the subexpression. For example, in the case of image creation, VM instance activation, and container activation, the image API, the VM instance API, and the container API are activated, respectively, and a search is performed as to whether or not the result of execution of the subexpression to be executed is already available on the basis of the hash value of the subexpression. In the case where the result of execution is available, each computational resource is put into an available state. In the case where the result of execution is not available, the subexpression is executed at an execution server, and the result is registered in a table in the execution server in association with the hash value of the subexpression.

In the case where the result of execution of processing based on the subexpression is data such as the result of playing a game app, the storage is searched for game result data associated with the has value. In the case where the game result data is not stored in the storage, since the game result data is not available, the subexpression is executed at an execution server, and the identification information of a computational resource serving as the result of execution is registered in the storage in association with the hash value of the subexpression.

In this embodiment, through “Hash-Type-ID management”, in which (1) a hash value (Hash) serving as identification information of a character string representation of an expression in a functional language, (2) the data type (Type) of the expression, and (3) identification information (ID) of a cloud resource (computational resource) are uniquely associated with each other as a triplet, it becomes possible to automatically extract and reuse processing that is common among a plurality of scripts, irrespective of the persons who created the scripts, the objectives of the scripts, or the order of execution of the scripts.

By using idempotent and referentially transparent expressions, a model is created in the form of a tree structure including only the definitions and calls of functions, not including any control structures such as conditional branches, recursions, and repetitions, and the order of description of a program on the tree structure is normalized, which makes it possible to assign the same character string representation to equivalent computational expressions. By using identification information such as a hash value identifying the character string representation, it is possible to uniquely identify an idempotent and referentially transparent expression. That is, by specifying restrictions concerning both the grammar and functions for writing scripts, the same identification information is calculated from equivalent computational expressions even if the computational expressions were included in scripts written by different users.

With this configuration, it becomes possible to check equivalence of computations on a cloud, such as creation of a virtual machine image, activation of a virtual machine (VM) instance, and writing of an app execution log to the cloud, and to reuse the result of equivalent computations. In the case where it takes a few minutes to create a VM image and it further takes a few tens of minutes to a few hours to activate a VM instance, when executing another script utilizing a VM instance activated on the basis of exactly the same VM image, if an already activated VM instance is available, by utilizing the VM instance, it becomes possible to execute processing by using the VM instance without requiring the time for creating and activating a VM image. It is also possible to reuse the data itself serving as the result of execution. It becomes possible to omit globally duplicate computations in constructing and running a system environment such as a cloud.

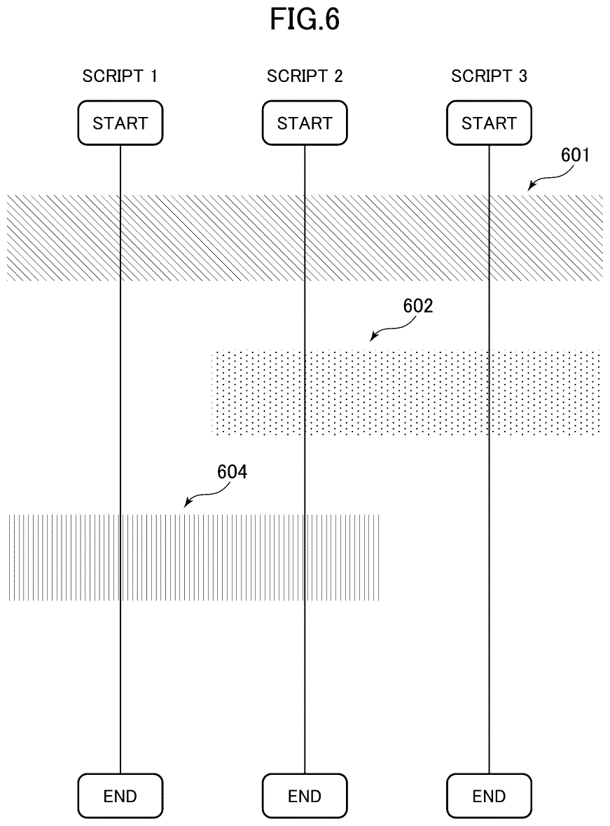

Next, examples in which the present invention can be utilized effectively will be described with reference to FIGS. 6 to 8. First, as a first example, an example in which the computation results of common subexpressions are shared will be described, which is an example of the simplest improvement in the efficiency of utilization of computational resources. In this example, in the case where a plurality of development projects are running concurrently, the results of execution (the results of evaluation) of subexpressions that are common among different scripts corresponding to the individual projects are shared.

In the example shown in FIG. 6, when there are three script files, processing shared among the individual script files is extracted, which makes it possible to reuse the result of a script executed earlier in a script executed later. Scripts 1 to 3 commonly include a subexpression 601, scripts 2 and 3 commonly include a subexpression 602, and scripts 1 and 2 commonly include a subexpression 604. In the case script 1 is executed first, script 2 is then executed, and script 3 is executed finally, the result of execution of the common subexpression 601, generated as a result of the execution of script 1, is reused in scripts 2 and 3, and the result of execution of the common subexpression 604 is reused in the execution of script 2. Furthermore, the result of execution of the subexpression 602, generated as a result of the execution of script 2, is reused in the execution of script 3.

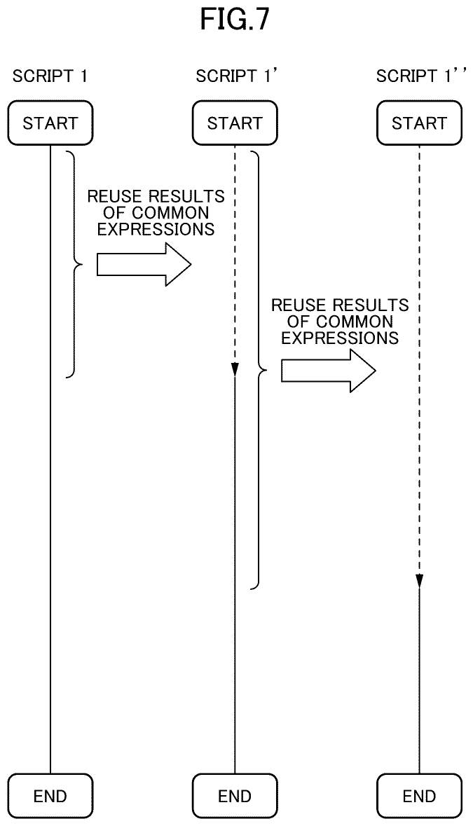

FIG. 7 shows a second example. This is an example of cascade sharing of computation results, in which the results of auto-execution of scripts by a machine are reused by humans. In this example, in the case where there is processing to be executed on an ad hoc basis while changing only a portion of a script that is continuously executed for 24 hours, it is possible to reuse an interim result of machine execution at arbitrary timing, which allows a human to execute other processing. For example, while automated debugging is being executed for 24 hours by using script 1 for the purpose of verification of a game system for executing a battle game using a deck including a plurality of cards, if a need arises for performing verification again only for a specific card, script 1′ in which only the definition of the card has been changed is introduced. Since all common portions are reused, it becomes possible to obtain the result of using the specific card in a shorter time compared with the case where the entire verification is executed again. Furthermore, even if script 1″ is introduced in the case where another developer wishes to continue testing while using a different card definition, all common portions are reused, and it becomes possible to obtain the result by executing only portions affected by changes in the specific card.

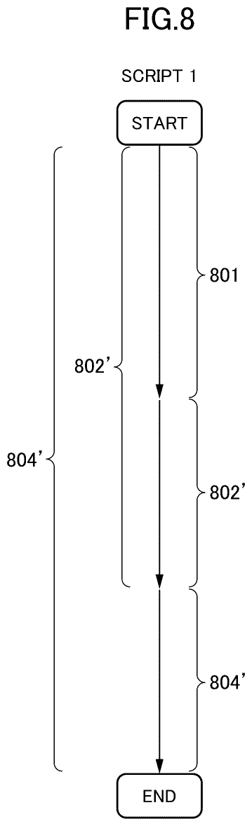

A third example shown in FIG. 8 is an example of differential execution, in which scripts are executed while reusing (skipping) the construction of virtual machines and battles satisfying a condition concerning the number of times of execution among already executed battles during incremental execution. In this example, after an expression 801 for executing battles of all combinations at least three times is executed, when an expression 802 for executing battles of all combinations at least ten times is executed, the results of execution of the expression 801 are reused for the three times executed earlier, and the expression 801 is executed only seven times constituting the difference (802′). Furthermore, when an expression 803 for executing battles of all combinations at least twenty times is executed, the results of earlier execution are reused for the three times and the seven times already executed, and the expression 803 is executed only ten times constituting the difference (804′). As described above, it becomes possible to perform multiplexed verification while selecting only cards or decks for which verification is to be performed carefully.

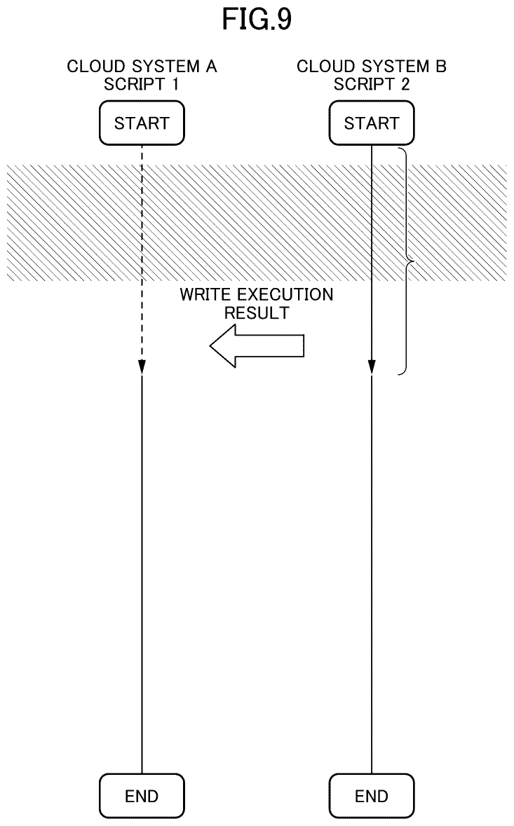

A fourth example shown in FIG. 9 is an example in which logic and execution privileges are segregated. This is an example in which verification can be executed seamlessly even in situations where cloud access privileges vary between a game development project and an auto-verification project. This example is useful in creating a game server clone. In FIG. 9, it is assumed that cloud system A is a cloud environment for automated verification and cloud system B is a cloud environment for developing and running a game. At this time, it is undesirable that cloud system A for automated verification is able to directly access cloud system B for developing and running a game from the viewpoint of security and information management. Meanwhile, it is all right to write necessary information from cloud system B for developing and running a game to cloud system A for automated verification.

In this case, when expressions executable with privileges of cloud system B are executed in the environment of cloud system B and the results are written to cloud system A for verification, it becomes possible to execute the expression as-is seamlessly in cloud system A for verification without having to include any scheme for privilege management in a verification program. Furthermore, the result of execution in the environment of cloud system B, written to cloud system A, can be reused in scripts that are executed later in cloud system A. This is because the result of computation of an expression is discriminated on the basis of the type and hash value of the expression and the cloud environment in which the expression was executed does not matter as long as the result of a common subexpression exists.

The processing or operation described above may be modified freely as long as no inconsistency arises in the processing or operation. Furthermore, each of the embodiments described above is an example for explaining the present invention, and the present invention is not limited to these embodiments. Some of the functions may be realized with an information processing device that is different from the information processing device described in the context of the embodiment. The present invention can be embodied in various forms as long as there is no departure from the spirit thereof. Furthermore, the advantages described in the context of the embodiment are merely a list of the most preferred advantages arising from the present invention, and advantages of the present invention are not limited to the advantages described in the context of the embodiment.

### REFERENCE SIGNS LIST

100 System
110 Control server
120 Processing execution server
130 Storage
140 Expression input terminal
150 Network
207 Communication device
211 Processor
212 Output device
213 Input device
216 Storage device
217 Communication device
218 Bus
219 Program
221 Processor
222 Output device
223 Input device
226 Storage device
227 Communication device
229 Program
241 Processor
242 Output device
243 Input device
246 Storage device
247 Communication device
248 Bus
249 Program
310 Control unit
311 Expression parsing unit
312 Computational-resource search unit
313 Execution-processing control unit
314 Computational-resource deletion unit
320 VM-image control unit
321 VM image
330 VM-instance control unit
331 VM instance
340 Container control unit
341 Container
350 Game-app control unit
391 Expression creation unit
392 Expression-execution instruction unit

1. A system that executes processing based on idempotent and referentially transparent expressions having idempotency and referential transparency, characterized in that:
identification information of a computational resource resulting from the execution of processing based on an idempotent and referentially transparent expression is stored in association with identification information of a character string representing the idempotent and referentially transparent expression as well as a data type of the idempotent and referentially transparent expression;
the identification information of the character string representing an idempotent and referentially transparent expression to be executed on the basis of an execution instruction to the system, as well as the data type of the idempotent and referentially transparent expression, are determined;
the stored identification information of computational resources is searched for the identification information of the computational resource associated with the identification information of the character string representing the idempotent and referentially transparent expression to be executed as well as the data type of the idempotent and referentially transparent expression; and
in the case where the identification information of the computational resource is identified through the search from the stored identification information of computational resources, it is determined that the computational resource identified on the basis of the identified identification information is used as the result of execution of processing based on the idempotent and referentially transparent expression to be executed.

2. The system according to claim 1, characterized in that in the case where processing based on a pair of the idempotent and referentially transparent expression to be executed and another idempotent and referentially transparent expression to be executed is to be executed, when the identification information of the computational resource is identified from the stored identification information of computational resources through the search, processing based on the other idempotent and referentially transparent expression is executed by using the computational resource identified on the basis of the identified identification information as the result of execution of the processing based on the idempotent and referentially transparent expression to be executed.

3. The system according to claim 1, characterized in that:
in the case where the identification information of the computational resource associated with the identification information of the character string representing the idempotent and referentially transparent expression to be executed as well as the data type of the idempotent and referentially transparent expression is not identified from the stored identification information of computational resource,
the processing based on the idempotent and referentially transparent expression to be executed is executed, and
the identification information of the character string representing the idempotent and referentially transparent expression to be executed and the data type of the idempotent and referentially transparent expression are stored in association with the determined identification information of the computational resource.

4. The system according to claim 1, characterized in that the identification information of the character string representing the idempotent and referentially transparent expression is determined on the basis of a normalized character string of the idempotent and referentially transparent expression.

5. The system according to claim 1, characterized in that the identification information of the character string representing the idempotent and referentially transparent expression is a hash value of the character string.

6. The system according to claim 1, characterized in that the processing based on the idempotent and referentially transparent expression includes at least one of virtual-machine-image creation processing, virtual-machine-instance activation processing, virtual-machine-image modification processing, virtual-machine-image copy processing, container activation processing, and non-destructive data write processing to a storage device by an application.

7. The system according to claim 1, characterized in that the computational resources include at least one of a process running in the system, a processor executing the process, a memory storing information concerning the process, and a memory storing the result of the execution processing.

8. The system according to claim 7, characterized in that the process includes at least one of a process of a virtual machine instance and a process for a container.

9. The method for executing processing based on idempotent and referentially transparent expressions by means of a computer, characterized by comprising:
a step of storing identification information of a computational resource resulting from the execution of processing based on an idempotent and referentially transparent expression in association with identification information of a character string representing the idempotent and referentially transparent expression as well as a data type of the idempotent and referentially transparent expression;
a step of determining the identification information of the character string representing an idempotent and referentially transparent expression to be executed on the basis of an execution instruction to the system, as well as the data type of the idempotent and referentially transparent expression;
a step of searching the stored identification information of computational resources for the identification information of the computational resource associated with the identification information of the character string representing the idempotent and referentially transparent expression to be executed as well as the data type of the idempotent and referentially transparent expression; and
in the case where the identification information of the computational resource is identified through the search from the stored identification information of computational resources, a step of determining that the computational resource identified on the basis of the identified identification information is used as the result of execution of processing based on the idempotent and referentially transparent expression to be executed.

10. A non-transitory computer readable medium storing a program for causing a computer to execute the method according to claim 9.

11. An information processing device that executes processing based on idempotent and referentially transparent expressions, wherein:
identification information of a computational resource resulting from the execution of processing based on an idempotent and referentially transparent expression is stored in association with identification information of a character string representing the idempotent and referentially transparent expression as well as a data type of the idempotent and referentially transparent expression;
the identification information of the character string representing an idempotent and referentially transparent expression to be executed on the basis of an execution instruction to the system, as well as the data type of the idempotent and referentially transparent expression, are determined;
the stored identification information of computational resources is searched for the identification information of the computational resource associated with the identification information of the character string representing the idempotent and referentially transparent expression to be executed as well as the data type of the idempotent and referentially transparent expression; and
in the case where the identification information of the computational resource is identified through the search from the stored identification information of computational resources, it is determined that the computational resource identified on the basis of the identified identification information is used as the result of execution of processing based on the idempotent and referentially transparent expression to be executed.
